(19) United States
(12) Patent Application Publication
(10) Pub. No.: US 2026/0360213 A1
(43) Pub. Date: Nov. 12, 2026

(54) MULTIPLE LOCKING PRIZE BOOSTING MECHANIC

(71) Applicant: Penn Interactive Ventures, LLC, Wyomissing, PA (US)

(72) Inventors: Mason McElroy, Las Vegas, NV (US); Andrew Duncan, Greenfield, MA (US)

(21) Appl. No.: 19/203,776

(22) Filed: May 9, 2025

(51) Int. Cl. G07F 17/32

(52) U.S. Cl. CPC G07F 17/3227; G07F 17/3213

(57) ABSTRACT

According to an aspect, a computer-implemented method includes activating a gameplay mechanic based detecting a spin event input through a user interface and calling a server to retrieve a plurality of spin results indicating a hit state, a first locking mechanic state, and a second locking mechanic state. The method also includes checking for a new instance of a first locking mechanic based on the first locking mechanic state and a second locking mechanic based on the second locking mechanic state, adjusting locking mechanic counters associated with the locking mechanics, applying multipliers based on the hit state and the locking mechanics being active, and displaying a hit visual indicator on the user interface.

### BACKGROUND

This disclosure generally relates to electronic gaming, and more particularly, to systems and methods of electronic game control including a multiple locking prize boosting mechanic.

Electronic gaming systems can be deployed as dedicated gaming machines that may be installed at casinos or other such locations. Online casino gaming can allow users to have a customized experience without traveling to a physical casino location. Gaming can involve the payment of credit that can be transferred between accounts and multiple games. Payment for gameplay and winning of games can increase or decrease the amount of credit that a player has available to cash out or use for other aspects, such as the purchase of merchandise, and/or payment for various products and services.

Player engagement can impact game utilization and player enjoyment. Features such as jackpots and variable prizes can enhance player engagement. Other features, such as game complexity and audio/visual appeal may also impact player engagement.

### SUMMARY

In one exemplary embodiment, a computer-implemented method for an electronic game is provided. The method includes activating, by a processing device, a gameplay mechanic based detecting a spin event input through a user interface, calling, by the processing device, a server to retrieve a plurality of spin results indicating a hit state, a first locking mechanic state, and a second locking mechanic state, and displaying, by the processing device, a non-hit visual indicator on the user interface based on receiving the hit state as a non-hit. The method further includes checking, by the processing device, for a new instance of a first locking mechanic based on the first locking mechanic state and a second locking mechanic based on the second locking mechanic state, and adjusting, by the processing device, a first locking mechanic counter associated with the first locking mechanic and a second locking mechanic counter associated with the second locking mechanic. The method additionally includes applying, by the processing device, a first multiplier based on a prize value associated with the hit state and the first locking mechanic being active, applying, by the processing device, a second multiplier based on the prize value associated with the hit state and the second locking mechanic being active, and displaying, by the processing device, a hit visual indicator on the user interface based on receiving the hit state as a hit.

In another exemplary embodiment, a system includes a memory with computer readable instructions and a processing device for executing the computer readable instructions. The computer readable instructions control the processing device to perform operations. The operations include activating a gameplay mechanic based detecting a spin event input through a user interface, calling a server to retrieve a plurality of spin results indicating a hit state, a first locking mechanic state, and a second locking mechanic state, and displaying a non-hit visual indicator on the user interface based on receiving the hit state as a non-hit. The operations also include checking for a new instance of a first locking mechanic based on the first locking mechanic state and a second locking mechanic based on the second locking mechanic state, and adjusting a first locking mechanic counter associated with the first locking mechanic and a second locking mechanic counter associated with the second locking mechanic. The operations further include applying a first multiplier based on a prize value associated with the hit state and the first locking mechanic being active, applying a second multiplier based on the prize value associated with the hit state and the second locking mechanic being active, and displaying a hit visual indicator on the user interface based on receiving the hit state as a hit.

In a further exemplary embodiment, a computer program product includes a storage medium embodied with computer program instructions that when executed by a computer cause the computer to implement: activating a gameplay mechanic based detecting a spin event input through a user interface, calling a server to retrieve a plurality of spin results indicating a hit state, a first locking mechanic state, and a second locking mechanic state, and displaying a non-hit visual indicator on the user interface based on receiving the hit state as a non-hit. The computer program instructions further cause the computer to implement: checking for a new instance of a first locking mechanic based on the first locking mechanic state and a second locking mechanic based on the second locking mechanic state, adjusting a first locking mechanic counter associated with the first locking mechanic and a second locking mechanic counter associated with the second locking mechanic, applying a first multiplier based on a prize value associated with the hit state and the first locking mechanic being active, applying a second multiplier based on the prize value associated with the hit state and the second locking mechanic being active, and displaying a hit visual indicator on the user interface based on receiving the hit state as a hit.

The above features and advantages, and other features and advantages, of the disclosure are readily apparent from the following detailed description when taken in connection with the accompanying drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 depicts a block diagram of an electronic gaming system environment according to one or more embodiments described herein;

FIG. 2A depicts a user interface prior to initiating gameplay according to one or more embodiments described herein;

FIG. 2B depicts a user interface after a hit state occurs without a locking mechanic being active according to one or more embodiments described herein;

FIG. 2C depicts a user interface with two locking mechanics active according to one or more embodiments described herein;

FIG. 3 is a flow diagram of a gameplay process with associated mechanics according to one or more embodiments described herein;

FIGS. 4A and 4B depict a flow diagram of a method for gameplay with a multiple locking prize boosting mechanic according to one or more embodiments described herein; and

FIG. 5 is a block diagram of a processing system according to one or more embodiments described herein.

The diagrams depicted herein are illustrative. There can be many variations to the diagram or the operations described therein without departing from the scope of the embodiments described herein. For instance, the actions can be performed in a differing order or actions can be added, deleted or modified. Also, the term “coupled” and variations thereof describes having a communications path between two elements and does not imply a direct connection between the elements with no intervening elements/connections between them. All of these variations are considered a part of the specification.

### DETAILED DESCRIPTION

One or more embodiments described herein relate to a multiple locking prize boosting mechanic for an electronic gaming system. Player engagement with an electronic gaming system can relate to enjoyment and excitement created through visual and audio effects. Effects can include animation, light patterns, simulated machine sounds, coin sounds, and other such visual and audio outputs. In games of chance that include a bonus or jackpot feature, players may continue to play in hopes of hitting a jackpot prize. However, jackpot prizes can have a lower probability of occurrence than regular prizes. The low occurrence rate of jackpot prizes can reduce player engagement. The use of prize multipliers of non-jackpot prizes can provide a middle ground to enhance player engagement, as multipliers of non-jackpot prizes can occur at a greater rate than the occurrence of jackpot prizes. In aspects as further described herein, a multiple locking prize boosting mechanic is provided that locks one or more prize boosting multipliers for multiple rounds of gameplay. A visual display of the state of the multiple locking prize boosting mechanic can provide user feedback to indicate a number of additional rounds of gameplay where non-jackpot prizes will be boosted in value should a winning game state hit while the multiple locking prize boosting mechanic is active. Accordingly, player engagement and enjoyment can be extended to multiple rounds of gameplay beyond the use of single gameplay multipliers.

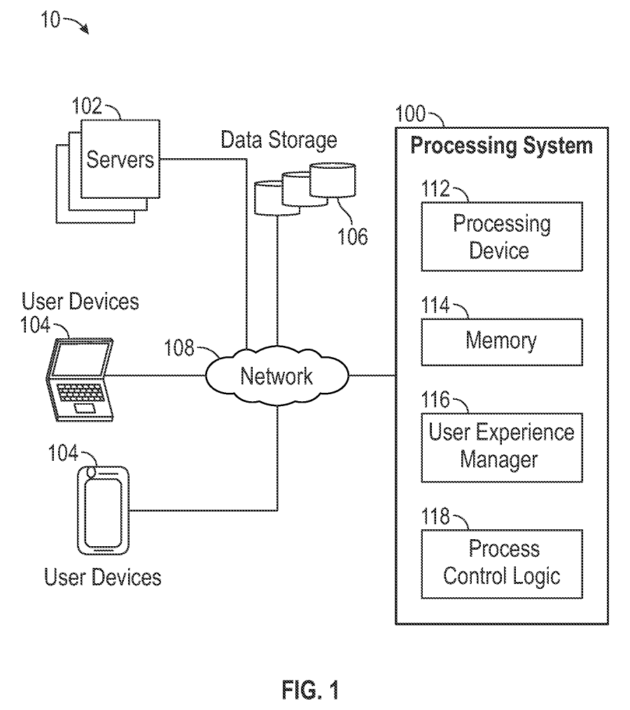

Turning now to FIG. 1, a system 10 is depicted in accordance with one or more embodiments. The system 10 includes a processing system 100 that can interact with one or more servers 102, user devices 104, and data storage 106 through a network 108. The processing system 100 can include a processing device 112 and memory 114. The memory 114 can include computer readable instructions. The processing device 112 can execute the computer readable instructions for controlling the processing device 112 to perform operations, such as executing a user experience manager 116, process control logic 118, and other applications and/or interfaces.

The various components, modules, applications, interfaces, etc. described regarding FIG. 1 (e.g., the user experience manager 116 and/or process control logic 118) can be implemented as instructions stored on a computer-readable storage medium, as hardware modules, as special-purpose hardware (e.g., application specific hardware, application specific integrated circuits (ASICs), application specific special processors (ASSPs), field programmable gate arrays (FPGAs), as embedded controllers, hardwired circuitry, etc.), or as some combination or combinations of these. According to aspects of the present disclosure, the components described herein can be a combination of hardware and programming. The programming can be processor executable instructions stored on a tangible memory, and the hardware can include the processing device 112 for executing those instructions. Thus, a system memory (e.g., memory 114) can store program instructions that when executed by the processing device 112 implement the manager, logic, and other functions described herein. Other components can also be utilized to include other features and functionality described in other examples herein. Further, aspects can be distributed between multiple processing devices and/or cloud computing based resources.

In one or more embodiments, the user experience manager 116 and/or process control logic 118 can be implemented on the processing system 100 of FIG. 1. In one or more other embodiments, the user experience manager 116 and/or process control logic 118 can be implemented, in whole or in part, using a cloud computing system (not shown). Cloud computing can supplement, support or replace some or all of the functionality of the elements of the processing system 100. Additionally, some or all of the functionality of the elements of the processing system 100 can be implemented as a cloud node of a cloud computing system. Thus, the processing system 100 can be distributed across multiple physical computer systems, which may be in different geographic locations.

The user experience manager 116 can manage allocation and deployment of resources to support application or web-based interfaces accessible by users through user devices 104. For example, gaming software with application programming interfaces (APIs) can reside on servers 102, and the user experience manager 116 can provide access to users through the user devices 104, where state data and other user data can be stored and retrieved through data storage 106. Thus, presentation layer aspects may display game-related content through a combination of the user experience manager 116, data stored on data storage 106, and software executed on or deployed by the servers 102. The process control logic 118 can control aspects of sharing user data across platforms, modifying user credits, presenting user-specific offers, and verifying user access/credentials. For example, the system 10 can blend aspects of physical and virtual experiences, such as online gaming, in-casino gaming, sportsbooks, and physical venues. In some aspects, the servers 102 can be partitioned into different service environments with associated data isolated in separate databases within the data storage 106. For instance, microservices with separate APIs can group online gaming with an online gaming database, a sportsbook API with a sportsbook database, and a casino API with a casino database. Core and edge services can manage transactions and data sharing between lower-level internally controlled core components and data with externally connected systems, such as user devices 104 and other third-party systems.

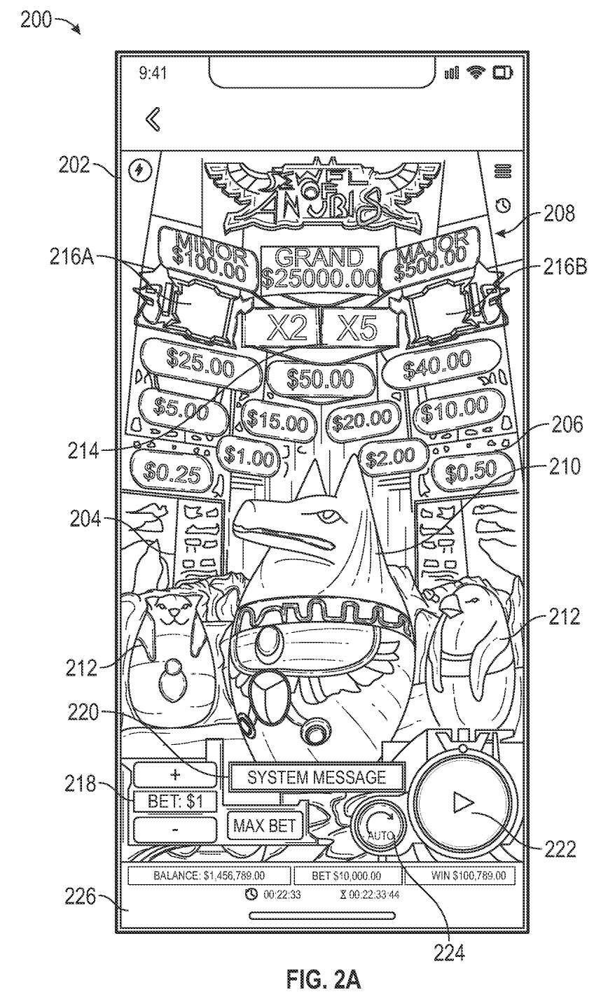

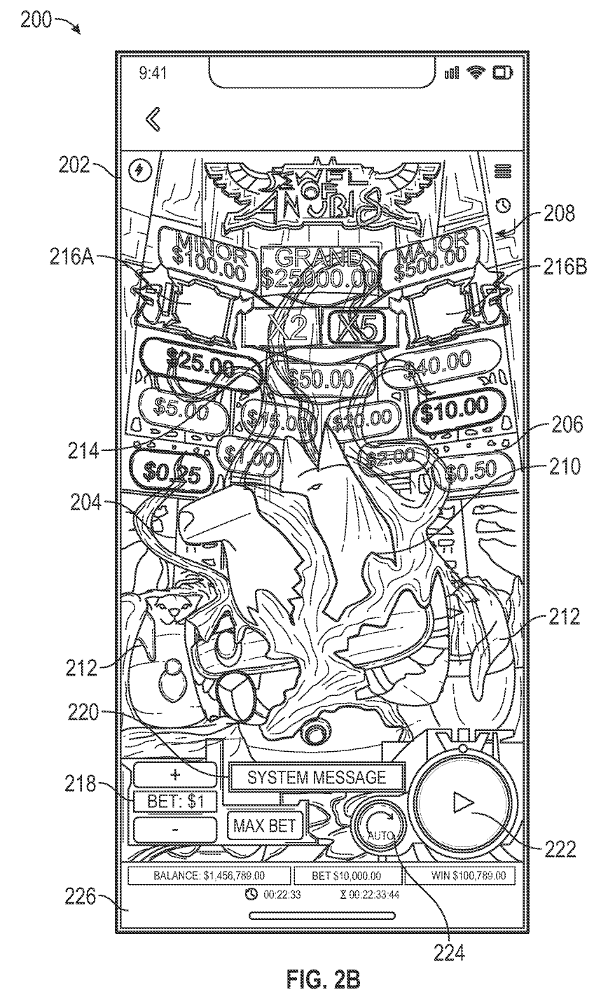

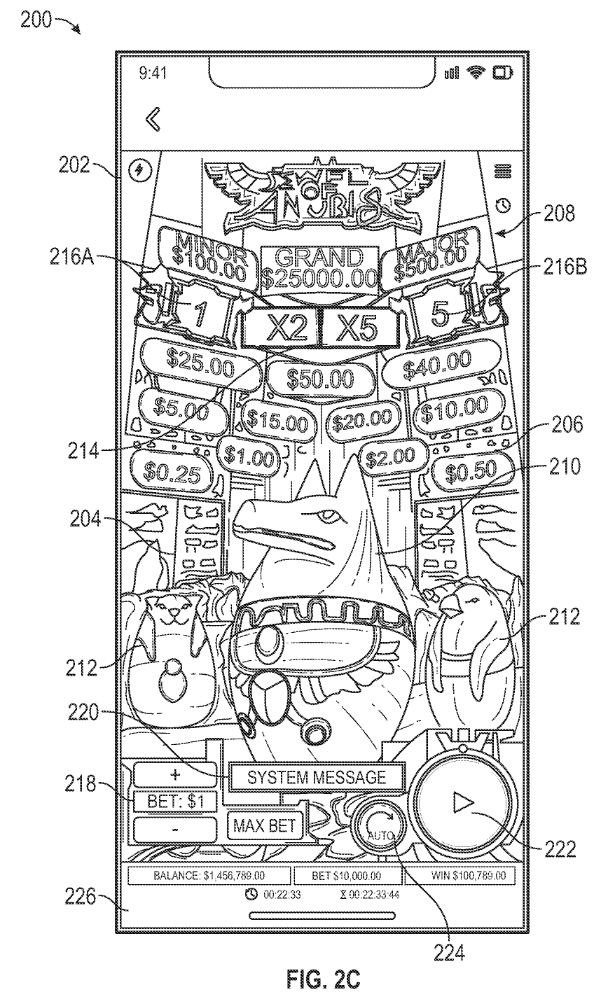

FIG. 2A depicts a user interface 200 of a game prior to initiating gameplay according to one or more embodiments. The user interface 200 can be generated by the user experience manager 116 of FIG. 1 for interactive use by users of the user devices 104 of FIG. 1. Game logic can be accessed through a gaming API of the servers 102 of FIG. 1, with state and credit tracking managed by the process control logic 118 of FIG. 1 or another component of the system 10 of FIG. 1.

In the example of FIG. 2A, the user interface 200 includes a jackpot amount indicator 202 that can express the value of multiple possible levels of jackpots which may be won upon hitting a jackpot prize. As one example, there can be three jackpot levels, such as minor, major, and grand. The potential value of each jackpot level can vary by multiples and/or orders of magnitude. In the example of FIG. 2A, the minor jackpot level may be about one hundred times the total wager, while the major jackpot level may be about five hundred times the total wager, and the grand jackpot may be about fifty times the major jackpot, for example. In some aspects, the specific values of the jackpots can change and grow over time as gameplay continues for multiple rounds. A bet level (e.g., a wager) can change the amounts of the jackpot levels. If a progressive jackpot is used, maintaining a same bet amount between multiple rounds of playing the game can result in adjusting the jackpot levels along one sequence of jackpot growth, while adjusting the bet amount up can transition to a different jackpot growth sequence. Similarly, reducing the bet amount can result in shifting to a different jackpot growth sequence. For example, three rounds of one dollar bets may increment the jackpots to a first level, and shifting the bet level to five dollar bets can switch to a second sequence of jackpot level growth. If the betting level is shifted back to a one dollar level, the jackpots can revert to the first level. Although an option of progressive jackpot growth is described, the jackpot values need not be implemented as a progressive jackpot.

In the example of FIG. 2A, the user interface 200 can include a background 204 that can display a plurality of possible prize values 206. The possible prize values 206 can change based on the current bet level. For instance, a smallest of the possible prize values 206 may be a quarter of the bet level and the largest of the possible prize values 206 can be fifty times the bet level with other values distributed in between. For instance, the possible prize values 206 can be half, one times, two times, five times, ten times, fifteen times, twenty times, twenty-five times, and/or forty times the bet level, and so forth. It will be understood that other values of the possible prize values 206 can be used.

The user interface 200 can also include two or more multiplier values 214. The multiplier values 214 can multiply any winnings of the possible prize values 206. For example, where the multiplier values 214 include an X2 multiplier and an X5 multiplier, hitting of the X2 multiplier can multiply any of the winning prizes of the possible prize values 206 by two. Similarly, hitting of the X5 multiplier can multiply any of the winning prizes of the possible prize values 206 by five. Thus, if both the X2 and X5 multipliers hit, then winning prizes of the possible prize values 206 would be multiplied by ten. The user interface 200 can also include one or more jewel indicators 216A, 216B. The jewel indicators 216A, 216B can display a state of first locking mechanic counter and a second locking mechanic counter respectively, which correlate to the number of remaining spins or gameplay events where corresponding multipliers are active. Jewel indicator 216A can be associated with the X2 multiplier of the multiplier values 214, and jewel indicator 216B can be associated with the X5 indicator of the multiplier values 214, for example.

If no prize hits, then a non-hit visual indicator can appear on the user interface 200, such as shaking animation of a prominent jar graphic 210, or other such indicator. Examples of indicators can include, a text-based message, an audio indication, an animation sequence, a graphical symbol, or combinations thereof.

In the example of FIG. 2A, the prominent jar graphic 210 may rotate positions with one or more background jars 212. Rotation of positions between the prominent jar graphic 210 and one or more background jars 212 can occur between gameplay rounds or upon events, such as winning a prize.

The user interface 200 can also include other user interface elements, such as a betting interface 218 to set/change bet levels, a system message interface 220 to display text-base messages, a spin button 222 to trigger gameplay, an autoplay button 224 to automate multiple rounds of gameplay, and a status region 226 to display information such as a balance, bet amount, win amount, and other such information (e.g., date, time, etc.). The betting interface 218 can allow a user to select a bet amount with incremental increases or decreases as well as a maximum bet option. The system message interface 220 can display text-based messages to the user before, during, or after gameplay. The current balance can be in the form of credits which may be transferred to play other games or used for other purposes. Other features of the user interface 200 can include gameplay mode status (e.g., auto/manual spin), menu controls, and navigation controls (e.g., to change the currently active game to a different game).

FIG. 2B depicts the user interface 200 after a hit state occurs without a locking mechanic being active according to one or more embodiments. Upon the spin button 222 of the user interface 200 being pressed or upon an auto-spin based on automatic play being activated through the autoplay button 224, a spin event can result in a hit state indicative of winning one or more prizes amounts. Multiple prizes can be won in response to a single spin event. Further, one or more of the multiplier values 214 can also be active to multiply the prize value. In the example of FIG. 2B, the X5 multiplier is active and the possible prize values 206 of $0.25, $10.00, and $25.00 have been won resulting in a base prize value of $35.25, which is multiplied by 5, resulting in a total winning amount of $176.25 based on a bet of $1. Since neither of the jewel indicators 216A, 216B is active in the example of FIG. 2B, the next spin can result in new hit results, which may include zero or more of the multiplier values 214 being active to boost non-jackpot winning values. Subsequent hit results may activate either or both of the locking mechanics associated with the jewel indicators 216A, 216B.

FIG. 2C depicts a user interface 200 with two locking mechanics active according to one or more embodiments. The jewel indicators 216A, 216B can indicate a number of turns remaining for each of the associated multiplier values 214 to be active. For example, a spin event can result in either or both of the locking mechanics becoming active based on tapping the spin button 222 or a spin request from autoplay button 224. Spin results can indicate a hit state, a first locking mechanic state associated with jewel indicator 216A, and a second locking mechanic state associated with jewel indicator 216B. Once the first locking mechanic associated with the jewel indicator 216A is set, a first locking mechanic counter associated with the first locking mechanic can be set to an initial value and then decremented upon each subsequent spin until reaching a value of zero. Similarly, once the second locking mechanic associated with the jewel indicator 216B is set, a second locking mechanic counter associated with the second locking mechanic can be set to an initial value and then decremented upon each subsequent spin until reaching a value of zero. Occurrence of the first locking mechanic state, the value of the first locking mechanic can be displayed by the jewel indicator 216A to indicate how many remaining turns of gameplay that the associated multiplier value 214 (e.g., X2) will remain active. Independent of the first locking mechanic state, the second locking mechanic state can be set as a result of a spin, with the value of the second locking mechanic counter displayed on the jewel indicator 216B which can be associated with a multiplier value 214 (e.g., X5). As one example, the first locking mechanic state can be set while the second locking mechanic is not set. After several turns of gameplay, the second locking mechanic may be set as well. During such a period of time, both multiplier values 214 can be active. Upon the first locking mechanic counter decrementing to zero, the value of the first locking mechanic counter may no longer be displayed in jewel indicator 216A. If the second locking mechanic activates after the first locking mechanic activates, the second locking mechanic can continue to remain active until the second locking mechanic counter decrements to zero. For instance, if the second locking mechanic activates when the first locking mechanic counter has a value of 1 and the second locking mechanic counter initializes to a value of 5, any prizes won during the overlapping turn would win 10X. Upon the next turn of gameplay, when the first locking mechanic counter decrements to 0 and the second locking mechanic counter decrements to 4, prizes would be multiplied by 5X. The 5X multiplier would remain active until the second locking mechanic counter decrements to 0.

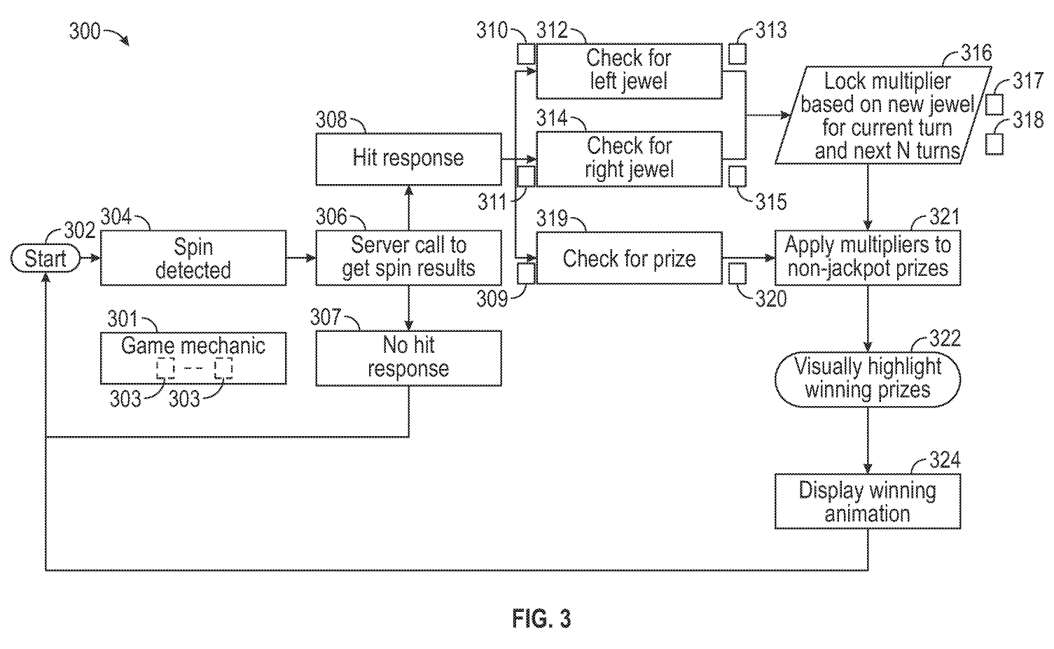

FIG. 3 is a flow diagram 300 of a gameplay process with associated mechanics according to one or more embodiments. The logic and flow depicted in the flow diagram 300 can be implemented by the user experience manager 116, process control logic 118, and/or other components of the system 10 of FIG. 1. In the example of FIG. 3, the gameplay process can be managed by a gameplay mechanic 301, which upon starting at block 302 can detect a press of a spin request at block 304. The spin request can be sent as a secure message (e.g., encrypted/encoded with source/destination validation) across network 108 to servers 102 at block 306 to retrieve spin results generated through one or more random number generators using one or more probability tables. Some aspects of random number generation can be based on one or more coinflip mechanics 303 that can use one or more probability tables for base level prizes, multipliers, jewels, and jackpots. Probabilities may change based on bet levels and/or length of gameplay (e.g., number of spin events in a same session and/or cumulative over multiple sessions), for instance, using weighting functions. Alternatively, probabilities can be predefined and may remain unchanged over time. The coinflip mechanics 303 can be implemented at the servers 102.

Results can be sent from the servers 102 across the network 108 as a secure message indicating a no hit response 307 or a hit response 308. The no hit response 307 can include a visual indicator and a return to block 302 to start gameplay again. The hit response 308 can include multiple indicators, such as a hit state 309 associated with winning one or more prizes, a first locking mechanic state 310 associated with a first locking mechanic 313, and a second locking mechanic state 311 associated with a second locking mechanic 315. At block 312, the first locking mechanic state 310 can be checked to determine whether the first locking mechanic 313 associated with a first or left jewel should be activated. At block 314, the second locking mechanic state 311 can be checked to determine whether the second locking mechanic 315 associated with a second or right jewel should be activated. At block 319, the hit state 309 can be checked to determine whether one or more prizes have been won and to determine a prize value 320 prior to application of any multipliers. At block 316, multipliers associated a new jewel (left or right) can be locked for a current turn and for the next N turns, where N is a number of additional turns for a jewel to remain active regardless of whether a hit or non-hit occurs. A first locking mechanic counter 317 can be associated with the first or left jewel, and a second locking mechanic counter 318 can be associated with the second or right jewel. A value first locking mechanic counter 317 associated with the first locking mechanic 313 can be displayed in the jewel indicator 216A when the first locking mechanic counter 317 is set to a non-zero value. A value of the second locking mechanic counter 318 associated with the second locking mechanic 315 can be displayed in the jewel indicator 216B when the second locking mechanic counter 318 is set to a non-zero value. For example, when a new instance of the first locking mechanic 313 occurs due to the first locking mechanic state 310, the first locking mechanic counter 317 can be set to an upper value, such as 5, and the value can be displayed within jewel indicator 216A. Similarly, when a new instance of the second locking mechanic 315 occurs due to the second locking mechanic state 311, the second locking mechanic counter 318 can be set to an upper value, such as 5, and the value can be displayed within jewel indicator 216B. If the first locking mechanic counter 317 and/or the second locking mechanic counter 318 is set to a non-zero value, the corresponding multiplier values 214 remain active for the number of spins indicated by the jewel indicators 216A, 216B.

At block 321, any multipliers from regular gameplay or as locked based on a jewel can be applied to non-jackpot prizes to determine a total prize amount. At block 322, winning prizes can be visually highlighted, such as changing a visual state of the possible prize values 206 corresponding to the individual winning prize values. Visual indication can include a change of color, brightness, and/or other such visual effects. At block 324, a winning animation can be displayed, such as motion/breaking of the prominent jar graphic 210, smoke effects, rotation of one or more background jars 212 to replace the prominent jar graphic 210, and/or other such effects. The player credit level is adjusted to reflect any winnings or non-winning that occurs during gameplay, which can be displayed in the status region 226. Upon completion of a round of gameplay, the process flow returns to block 302.

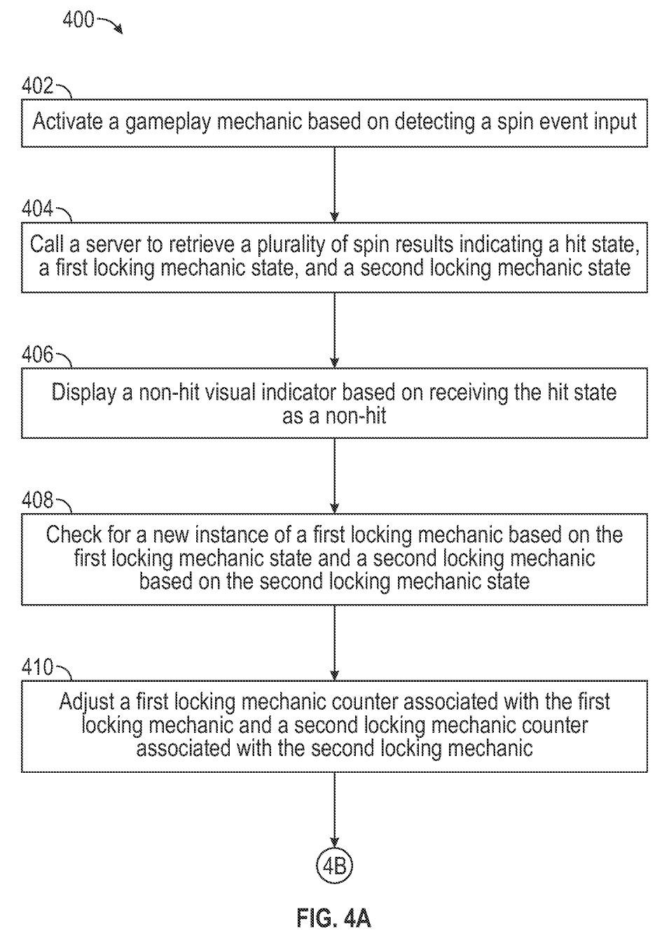

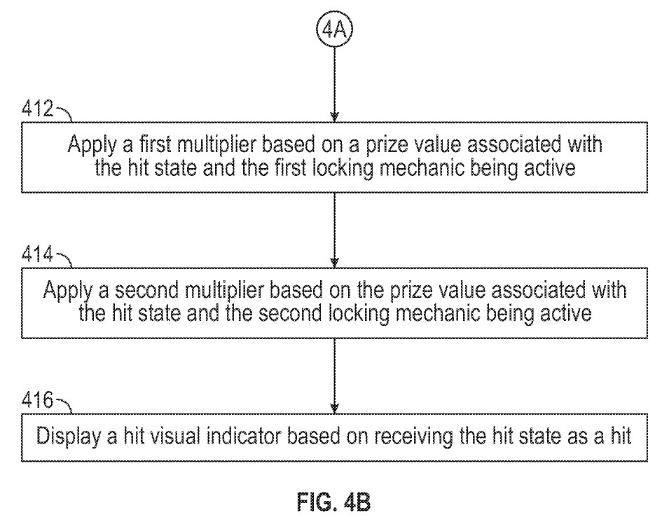

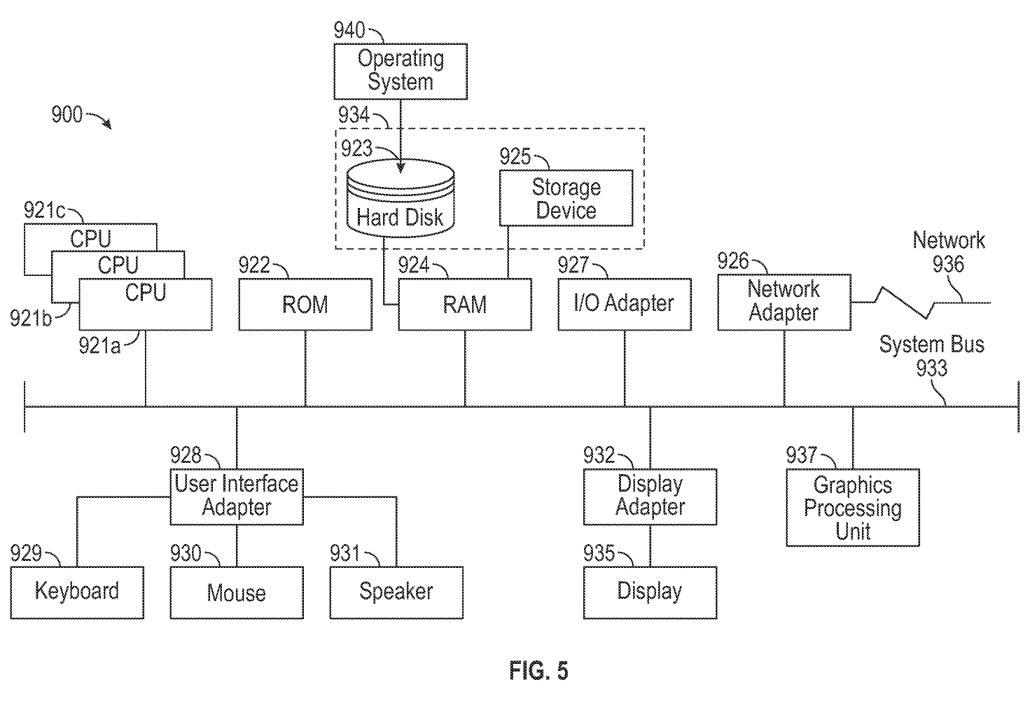

FIGS. 4A and 4B depict a flow diagram of a method 400 for gameplay with a multiple locking prize boosting mechanic according to one or more embodiments described herein. The method 400 can be implemented by any suitable device or system, such as the processing system 100 of FIG. 1 and/or the processing system 900 of FIG. 5 as a computer-implemented method. For example, the method 400 can be performed by the processing device 112 executing computer readable instructions stored in the memory 114 to perform functions of the user experience manager 116 and/or process control logic 118 of FIG. 1. Further, aspects of the method 400 can be performed in a distributed manner, such as portions being performed by one or more of the servers 102, user devices 104, processing system 100, and/or other cloud-based resources. The method 400 is described with reference to FIGS. 1-4B. The multiple locking prize boosting mechanic can be implemented by gameplay mechanic 301 as part of the gameplay process as illustrated in flow diagram 300.

At block 402, a gameplay mechanic 301 is activated based detecting a spin event input through user interface 200. This can be performed spin detection at block 304 in response detecting an input, such as tapping the spin button 222 or a spin request from autoplay button 224.

At block 404, a server (e.g., one or more of servers 102) can be called to retrieve a plurality of spin results indicating a hit state 309, a first locking mechanic state 310, and a second locking mechanic state 311. At block 406, a non-hit visual indicator can be displayed on the user interface 200 based on receiving the hit state 309 as a non-hit. At block 408, a check for a new instance of a first locking mechanic 313 is performed based on the first locking mechanic state 310, and a check for a new instance of a second locking mechanic 315 is performed based on the second locking mechanic state 311. At block 410, a first locking mechanic counter 317 associated with the first locking mechanic 313 and a second locking mechanic counter 318 associated with the second locking mechanic 315 can be adjusted. At block 412, a first multiplier can be applied based on a prize value associated with the hit state 309 and the first locking mechanic 313 being active. At block 414, a second multiplier can be applied based on the prize value associated with the hit state 309 and the second locking mechanic 315 being active. At block 416, a hit visual indicator can be displayed on the user interface 200 based on receiving the hit state 309 as a hit.

According to some aspects, the first locking mechanic state 310 and the second locking mechanic state 311 can be determined independent of each other based on one or more coinflip mechanics 303.

According to some aspects, the first locking mechanic counter 317 can be set to an upper value based on detecting the new instance of a first locking mechanic 313 and decremented on each subsequent spin until reaching a value of zero.

According to some aspects, a value of the first locking mechanic counter 317 can be displayed on the user interface while the value is greater than zero, such as in jewel indicator 216A.

According to some aspects, the second locking mechanic counter 318 can be set to an upper value based on detecting the new instance of a second locking mechanic 315 and decremented on each subsequent spin until reaching a value of zero.

According to some aspects, a value of the second locking mechanic counter 318 can be displayed on the user interface 200 while the value is greater than zero, such as in jewel indicator 216B.

According to some aspects, applying the first multiplier and applying the second multiplier can be based on determining that the prize value is a non-jackpot prize.

According to some aspects, a plurality of prize values can be displayed on the user interface 200 in a pre-spin state, and the hit visual indicator can include visually highlighting one or more of the prize values on the user interface 200 that match the prize value associated with the hit state 309.

Additional processes also may be included, and it should be understood that the process depicted in FIG. 4 represents an illustration, and that other processes may be added or existing processes may be removed, modified, or rearranged without departing from the scope of the present disclosure.

Example embodiments of the disclosure include or yield various technical features, technical effects, and/or improvements to technology. Example embodiments of the disclosure provide visual feedback to the user about a number of rounds of gameplay where one or more prize multipliers will be active. The locking prize boosting mechanic can be separately determined and may result in an extended number of gameplay rounds where at least one multiplier is active. These aspects of the disclosure constitute technical features that yield the technical effect of status feedback (e.g., using a visual change indicator) is performed in an efficient and effective way that cannot practically be performed in the human mind. As a result of these technical features and technical effects, a system in accordance with example embodiments of the disclosure represents an improvement to data processing and visual communication techniques. It should be appreciated that the above examples of technical features, technical effects, and improvements to technology of example embodiments of the disclosure are merely illustrative and not exhaustive.

It is understood that one or more aspects described herein is capable of being implemented in conjunction with any other type of computing environment now known or later developed. For example, FIG. 5 depicts a block diagram of a processing system 900 for implementing the techniques described herein. In examples, processing system 900 has one or more central processing units (“processors” or “processing resources” or “processing devices”) 921a, 921b, 921c, etc. (collectively or generically referred to as processor(s) 921 and/or as processing device(s)). In aspects of the present disclosure, each processor 921 can include a reduced instruction set computer (RISC) microprocessor. Processors 921 are coupled to system memory (e.g., random access memory (RAM) 924) and various other components via a system bus 933. Read only memory (ROM) 922 is coupled to system bus 933 and may include a basic input/output system (BIOS), which controls certain basic functions of processing system 900.

Further depicted are an input/output (I/O) adapter 927 and a network adapter 926 coupled to system bus 933. I/O adapter 927 may be a small computer system interface (SCSI) adapter that communicates with a hard disk 923 and/or a storage device 925 or any other similar component. I/O adapter 927, hard disk 923, and storage device 925 are collectively referred to herein as mass storage 934. Operating system 940 for execution on processing system 900 may be stored in mass storage 934. The network adapter 926 interconnects system bus 933 with an outside network 936 enabling processing system 900 to communicate with other such systems.

A display 935 (e.g., a display monitor) is connected to system bus 933 by display adapter 932, which may include a graphics adapter to improve the performance of graphics intensive applications and a video controller. In one aspect of the present disclosure, adapters 926, 927, and/or 932 may be connected to one or more I/O busses that are connected to system bus 933 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 933 via user interface adapter 928 and display adapter 932. A keyboard 929, mouse 930, and speaker 931 may be interconnected to system bus 933 via user interface adapter 928, which may include, for example, a Super I/O chip integrating multiple device adapters into a single integrated circuit.

In some aspects of the present disclosure, processing system 900 includes a graphics processing unit 937. Graphics processing unit 937 is a specialized electronic circuit designed to manipulate and alter memory to accelerate the creation of images in a frame buffer intended for output to a display. In general, graphics processing unit 937 is very efficient at manipulating computer graphics and image processing and has a highly parallel structure that makes it more effective than general-purpose CPUs for algorithms where processing of large blocks of data is done in parallel.

Thus, as configured herein, processing system 900 includes processing capability in the form of processors 921, storage capability including system memory (e.g., RAM 924), and mass storage 934, input means such as keyboard 929 and mouse 930, and output capability including speaker 931 and display 935. In some aspects of the present disclosure, a portion of system memory (e.g., RAM 924) and mass storage 934 collectively store the operating system 940 to coordinate the functions of the various components shown in processing system 900.

It is to be understood that the block diagram of FIG. 5 is not intended to indicate that the processing system 900 is to include all of the components shown in FIG. 5. Rather, the processing system 900 can include any appropriate fewer or additional components not illustrated in FIG. 5 (e.g., additional memory components, embedded controllers, modules, additional network interfaces, etc.). Further, the aspects described herein with respect to processing system 900 may be implemented with any appropriate logic, wherein the logic, as referred to herein, can include any suitable hardware (e.g., a processor, an embedded controller, or an application-specific integrated circuit, among others), software (e.g., an application, among others), firmware, or any suitable combination of hardware, software, and firmware, in various aspects.

In yet another exemplary embodiment a computer program product includes a computer readable storage medium having program instructions embodied therewith, where the computer readable storage medium is not a transitory signal per se, the program instructions executable by a processing device to cause the processing device to perform operations as disclosed above.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

The flowchart and block diagrams in the figures illustrate the architecture, functionality, and operation of possible implementations of systems, methods, and computer program products according to various embodiments described herein. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments described herein have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A computer-implemented method comprising:
activating, by a processing device, a gameplay mechanic based detecting a spin event input through a user interface;
calling, by the processing device, a server to retrieve a plurality of spin results indicating a hit state, a first locking mechanic state, and a second locking mechanic state;
displaying, by the processing device, a non-hit visual indicator on the user interface based on receiving the hit state as a non-hit;
checking, by the processing device, for a new instance of a first locking mechanic based on the first locking mechanic state and a second locking mechanic based on the second locking mechanic state;
adjusting, by the processing device, a first locking mechanic counter associated with the first locking mechanic and a second locking mechanic counter associated with the second locking mechanic;
applying, by the processing device, a first multiplier based on a prize value associated with the hit state and the first locking mechanic being active;
applying, by the processing device, a second multiplier based on the prize value associated with the hit state and the second locking mechanic being active; and
displaying, by the processing device, a hit visual indicator on the user interface based on receiving the hit state as a hit.

2. The computer-implemented method of claim 1, wherein the first locking mechanic state and the second locking mechanic state are determined independent of each other based on one or more coinflip mechanics.

3. The computer-implemented method of claim 1, wherein the first locking mechanic counter is set to an upper value based on detecting the new instance of a first locking mechanic and decremented on each subsequent spin until reaching a value of zero.

4. The computer-implemented method of claim 3, wherein a value of the first locking mechanic counter is displayed on the user interface while the value is greater than zero.

5. The computer-implemented method of claim 1, wherein the second locking mechanic counter is set to an upper value based on detecting the new instance of a second locking mechanic and decremented on each subsequent spin until reaching a value of zero.

6. The computer-implemented method of claim 5, wherein a value of the second locking mechanic counter is displayed on the user interface while the value is greater than zero.

7. The computer-implemented method of claim 1, wherein applying the first multiplier and applying the second multiplier are based on determining that the prize value is a non-jackpot prize.

8. The computer-implemented method of claim 1, wherein a plurality of prize values are displayed on the user interface in a pre-spin state, and the hit visual indicator comprises visually highlighting one or more of the prize values on the user interface that match the prize value associated with the hit state.

9. A system comprising:
a memory comprising computer readable instructions; and
a processing device for executing the computer readable instructions, the computer readable instructions controlling the processing device to perform operations comprising:
activating a gameplay mechanic based detecting a spin event input through a user interface;
calling a server to retrieve a plurality of spin results indicating a hit state, a first locking mechanic state, and a second locking mechanic state;
displaying a non-hit visual indicator on the user interface based on receiving the hit state as a non-hit;
checking for a new instance of a first locking mechanic based on the first locking mechanic state and a second locking mechanic based on the second locking mechanic state;
adjusting a first locking mechanic counter associated with the first locking mechanic and a second locking mechanic counter associated with the second locking mechanic;
applying a first multiplier based on a prize value associated with the hit state and the first locking mechanic being active;
applying a second multiplier based on the prize value associated with the hit state and the second locking mechanic being active; and
displaying a hit visual indicator on the user interface based on receiving the hit state as a hit.

10. The system of claim 9, wherein the first locking mechanic state and the second locking mechanic state are determined independent of each other based on one or more coinflip mechanics.

11. The system of claim 9, wherein the first locking mechanic counter is set to an upper value based on detecting the new instance of a first locking mechanic and decremented on each subsequent spin until reaching a value of zero.

12. The system of claim 11, wherein a value of the first locking mechanic counter is displayed on the user interface while the value is greater than zero.

13. The system of claim 9, wherein the second locking mechanic counter is set to an upper value based on detecting the new instance of a second locking mechanic and decremented on each subsequent spin until reaching a value of zero.

14. The system of claim 13, wherein a value of the second locking mechanic counter is displayed on the user interface while the value is greater than zero.

15. The system of claim 9, wherein applying the first multiplier and applying the second multiplier are based on determining that the prize value is a non-jackpot prize.

16. The system of claim 9, wherein a plurality of prize values are displayed on the user interface in a pre-spin state, and the hit visual indicator comprises visually highlighting one or more of the prize values on the user interface that match the prize value associated with the hit state.

17. A computer program product comprising a storage medium embodied with computer program instructions that when executed by a computer cause the computer to implement:
activating a gameplay mechanic based detecting a spin event input through a user interface;
calling a server to retrieve a plurality of spin results indicating a hit state, a first locking mechanic state, and a second locking mechanic state;
displaying a non-hit visual indicator on the user interface based on receiving the hit state as a non-hit;
checking for a new instance of a first locking mechanic based on the first locking mechanic state and a second locking mechanic based on the second locking mechanic state;
adjusting a first locking mechanic counter associated with the first locking mechanic and a second locking mechanic counter associated with the second locking mechanic;
applying a first multiplier based on a prize value associated with the hit state and the first locking mechanic being active;
applying a second multiplier based on the prize value associated with the hit state and the second locking mechanic being active; and
displaying a hit visual indicator on the user interface based on receiving the hit state as a hit.

18. The computer program product of claim 17, wherein the first locking mechanic counter is set to an upper value based on detecting the new instance of a first locking mechanic and decremented on each subsequent spin until reaching a value of zero; the second locking mechanic counter is set to the upper value based on detecting the new instance of a second locking mechanic and decremented on each subsequent spin until reaching a value of zero; and the first locking mechanic state and the second locking mechanic state are determined independent of each other based on one or more coinflip mechanics.

19. The computer program product of claim 17, wherein applying the first multiplier and applying the second multiplier are based on determining that the prize value is a non-jackpot prize.

20. The computer program product of claim 17, wherein a plurality of prize values are displayed on the user interface in a pre-spin state, and the hit visual indicator comprises visually highlighting one or more of the prize values on the user interface that match the prize value associated with the hit state.
